(19) United States
(12) Patent Application Publication
(10) Pub. No.: US 2012/0022925 A1
(43) Pub. Date: Jan. 26, 2012

(54) METHOD FOR BROADCASTING ADVERTISEMENTS ON ELECTRONIC DEVICE

(75) Inventors: Yen-An CHEN, Tu-Cheng (TW); Chiu-Hao CHEN, Tu-Cheng (TW); Chih-Chien CHU, Tu-Cheng (TW)

(73) Assignee: CHI MEI COMMUNICATION SYSTEMS, INC., Tu-Cheng City (TW)

(21) Appl. No.: 12/915,019

(22) Filed: Oct. 29, 2010

(30) Foreign Application Priority Data
Jul. 21, 2010 (TW) 99124017

(51) Int. Cl. G06Q 30/00

(52) U.S. Cl. 705/14.4

(57) ABSTRACT

A method for broadcasting advertisements is used on an electronic device. The electronic device may download the advertisements from a server of an advertiser. When the electronic device is awaked from a sleep state, the advertisements are broadcasted on a display of the electronic device. After the advertisements are broadcasted, the display then displays a window already displayed on the display before the electronic device enters the sleep state.

### BACKGROUND

1. Technical Field

The present disclosure relates to a method for broadcasting advertisements on an electronic device.

2. Description of Related Art

Current technology allows advertisements to be broadcasted to personal electronic devices. However, such advertisement occurs without the permission of the device user, such that the broadcasted material constitutes an unwelcome intrusion.

### BRIEF DESCRIPTION OF THE DRAWINGS

FIG. 1 is a block diagram of an electronic device in communication with a server of an advertiser through a network.

FIG. 2 is a block diagram of one embodiment of the electronic device of FIG. 1.

FIGS. 3A-3B are flowcharts illustrating one embodiment of a method for broadcasting advertisements on an electronic device.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

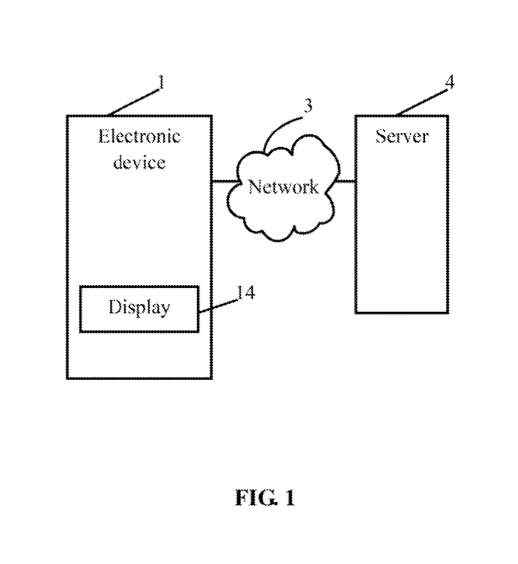

FIG. 1 is a block diagram of an electronic device 1 in communication with a server 4 of an advertiser through a network 3. The electronic device 1 may be a mobile phone, or a personal digital assistant (PDA), for example. The server 4 is a computerized system that stores advertisements of the advertiser. The network 3 may be a mobile telecommunication network or the Internet. In the embodiment, the network 3 is a mobile telecommunication network, such as Global System for Mobile communication (GSM) network, or International Mobile Telephonicommunications-2000 (IMT-2000) network, for example.

The electronic device 1 is generally controlled and coordinated by an operating system, such as UNIX, Linux, Windows, Mac OS, an embedded operating system, or any other compatible system. Alternatively, the electronic device 1 may be controlled by a proprietary operating system. Typical operating systems control and schedule computer processes for execution, perform memory management, provide file system, networking, and I/O services, and provide a user interface, such as a graphical user interface (GUI), among other tasks.

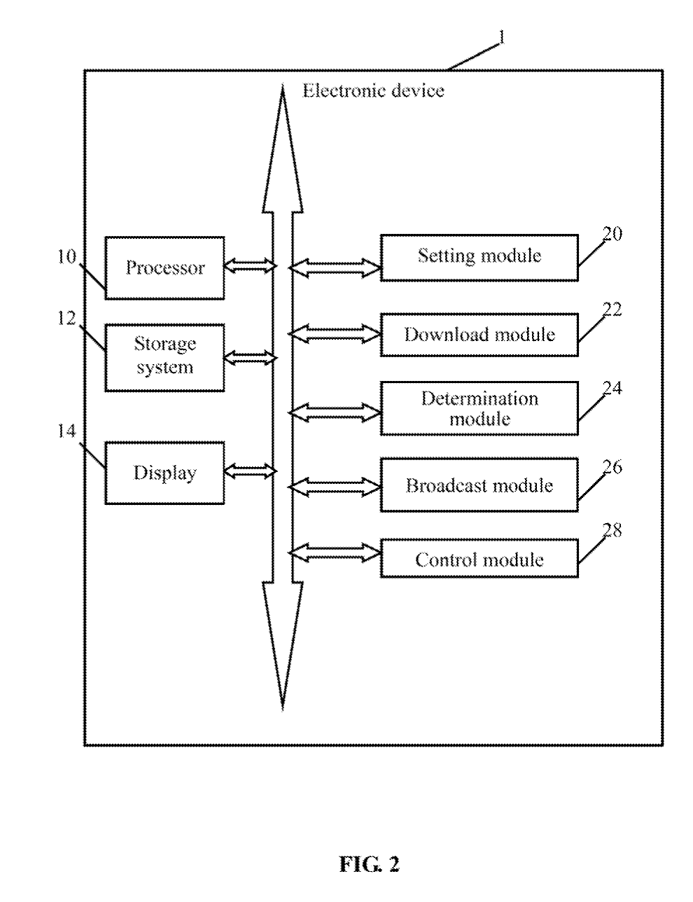

FIG. 2 is a block diagram of one embodiment of the electronic device 1 of FIG. 1. The electronic device 1 includes a processor 10, a storage system 12, a display 14, a setting module 20, a download module 22, a determination module 24, a transmission module 26, and a control module 28. The modules 20-28 may comprise computerized code in the form of one or more programs that are stored in the storage system 12. The computerized code includes instructions that are executed by the processor 10 to provide functions for the modules 20-28.

The setting module 20 is operable to provide an advertisement function on the electronic device 1. The advertisement function is defined as a function that allows the electronic device 1 to download the advertisements from the server 4 of the advertiser and broadcast the advertisements. In one example, the setting module 20 can display an option (not shown) on the display 14, which is operable to activate the advertisement function upon selection by a user. Upon selection of the advertisement function by the user, the download module 22 is operable to download advertisements from the server 4 of the advertiser. The advertisements may be in the form of text, static images, dynamic images, or audio, for example. The electronic device 1 may broadcast the advertisement on the display 14 when being awaked from a sleep state when the advertisement function is activated.

The sleep state is a low power consumption state for the electronic device 1, which may save significant power consumption, but allow users to avoid having to reset programming codes or wait for rebooting. The sleep state may be called different names, including Stand By (for Microsoft Windows 95-Server 2003), Sleep (for Mac OS 8-Mac OS X, Windows Vista, Windows 7, Windows Server 2008), and Suspend (for Linux).

The determination module 24 determines whether the electronic device 1 has stored the advertisements in the storage system 12 before the electronic device 1 enters the sleep state. The transmission module 26 broadcasts the advertisements on the display 14. The control module 28 restores a window already displayed on the display 14 before the electronic device 1 enters the sleep state after the advertisements are broadcasted. The window may include a menu window, an editing window of short message, a media player window, and others, for example. If the storage system 12 stores no advertisements, the control module 28 prevents the electronic device 1 from entering the sleep state until the advertisements are downloaded. The control module 28 further instructs the electronic device to enter the sleep state if the electronic device is unable to download the advertisements within a time interval. In the embodiment, the time interval is a default.

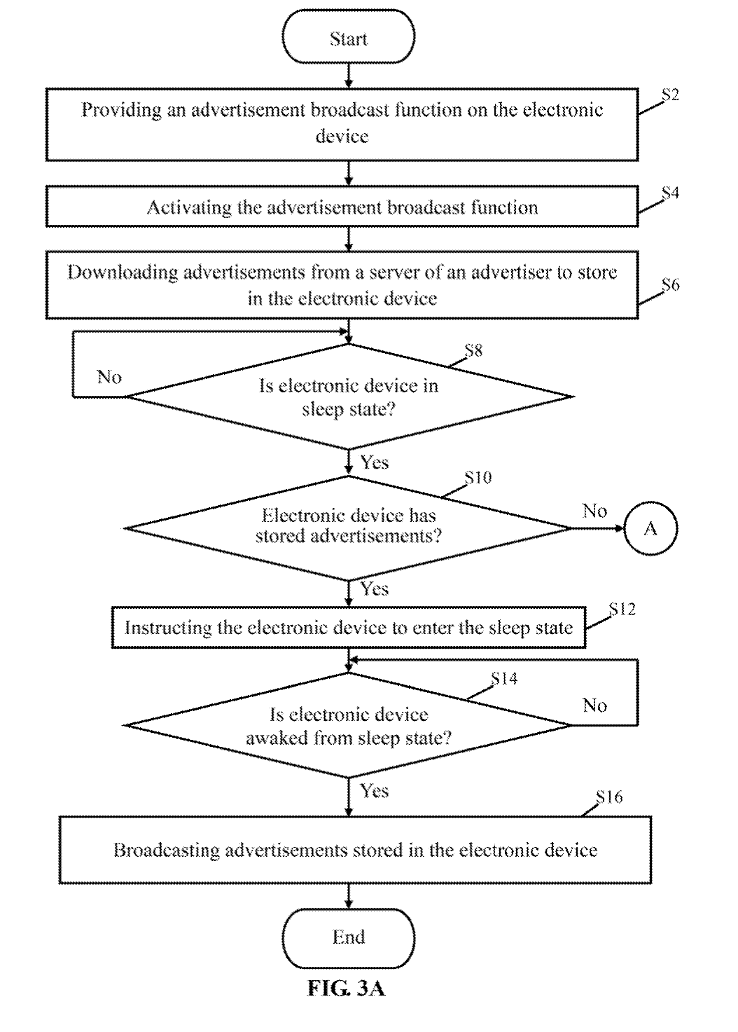

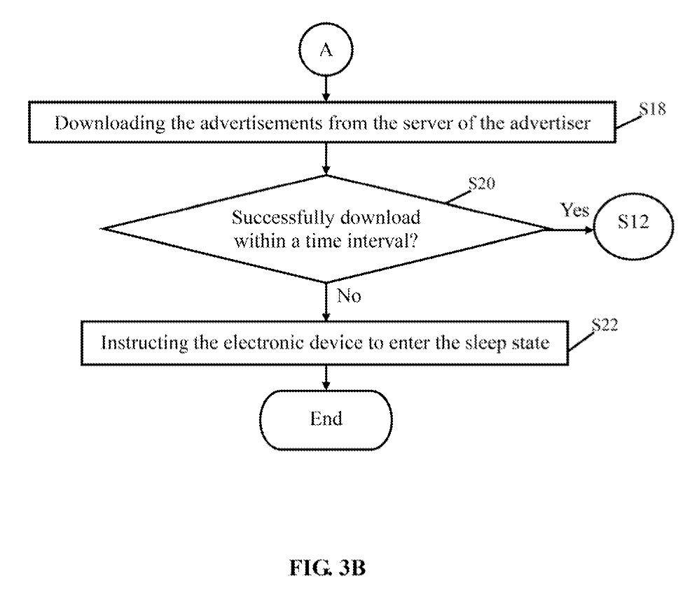

FIGS. 3A-3B are flowcharts illustrating one embodiment of a method for broadcasting advertisements to the electronic device 1. Depending on the embodiment, additional blocks may be added, others removed, and the ordering of the blocks may be changed.

In block S2, the setting module 20 provides the advertisement function on the electronic device 1.

In block S4, the advertisement function is activated by a user.

In block S6, the download module 22 downloads the advertisements from the server 4 of the advertiser to store in the electronic device 1.

In block S8, the determination module 24 determines whether the electronic device 1 is in the sleep state. If the electronic device 1 is not in the sleep state, block S8 is repeated.

If the electronic device 1 is in the sleep state, in block S10, the determination module 24 further determines whether the electronic device 1 has stored the advertisements. If the electronic device 1 has not stored the advertisements, block S18 is implemented.

If the electronic device 1 has stored the advertisements, in block S12, the control module 28 instructs the electronic device 1 to enter the sleep state.

In block S14, the determination module 24 determines whether the electronic device 1 is awaked from the sleep state. If the electronic device 1 is not awaked from the sleep state, block S14 is repeated.

In block S16, the transmission module 26 broadcasts the advertisements stored in the electronic device 1.

In block 18, the download module 22 connects to the server 4 of the advertiser through the network 3 and downloads the advertisements from the server 4.

In blocks S20, the determination module 24 determines whether the advertisements are successfully downloaded within the time interval. If the advertisements are not downloaded within the time interval, block S12 is repeated.

If the advertisement is downloaded within the time interval, in block S22, the control module 28 instructs the electronic device 1 to enter the sleep state. The process is complete.

The present disclosure provides a method for broadcasting advertisements to an electronic device without disturbing users. The interests of advertisers are also maintained.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for broadcasting advertisements to an electronic device, the electronic device comprises a display, the method comprising:
downloading the advertisements from a server through a network to store in the electronic device when an advertisement function of the electronic device is activated;
broadcasting the advertisements to the electronic device when the electronic device is awaked from a sleep state; and
restoring a window already displayed on the display before the electronic device enters the sleep state after broadcasting of the advertisements.

2. The method of claim 1, further comprising:
determining whether the electronic device has stored the advertisements before the electronic device enters the sleep state; and
preventing the electronic device from entering the sleep state until the advertisements have been broadcasted on the electronic device if the electronic device stores no advertisements.

3. The method of claim 2, further comprising:
instructing the electronic device to enter the sleep state when the advertisements are unable to be broadcasted on the electronic device.

4. An electronic device, comprising:
a display;
a storage system;
at least one processor;
one or more programs that are stored in the storage system and are executed by the at least one processor, the one or more programs comprising:
a setting module operable to provide an advertisement function on the electronic device;
a download module operable to download advertisements from a server to the electronic device through a network;
a broadcast module operable to broadcast the advertisements; and
a control module operable to restore a window already displayed on the display before the electronic device enters the sleep state after broadcasting of the advertisements.

5. The electronic device of claim 4, further comprises:
a determination module operable to determine whether the electronic device has stored the advertisements before the electronic device enters the sleep state.

6. The electronic device of claim 5, wherein the control module prevents the electronic device from entering the sleep state until the advertisements have been downloaded if the electronic device stores no advertisements.

7. The electronic device of claim 5, wherein the control module instructs the electronic device to enter the sleep state when the electronic device is unable to download the advertisements.

8. A storage medium having stored thereon instructions that, when executed by a processor, causing the processor to perform a method for broadcasting advertisements to an electronic device, the electronic device comprises a display, wherein the method comprises:
download the advertisements from a server through a network to store in the electronic device when an advertisement function of the electronic device is activated;
broadcast the advertisements to the electronic device when the electronic device is awaked from a sleep state; and
restore a window already displayed on the display before the electronic device enters the sleep state after broadcasting of the advertisements.

9. The storage medium of claim 8, wherein the method comprises:
determine whether the electronic device has stored the advertisements before the electronic device enters the sleep state; and
prevent the electronic device from entering the sleep state until the advertisements have been broadcasted on the electronic device if the electronic device stores no advertisements.

10. The storage medium of claim 9, wherein the method comprises:
instruct the electronic device to enter the sleep state when the advertisements are unable to be broadcasted on the electronic device.
